(19) United States
(12) Patent Application Publication
(10) Pub. No.: US 2010/0052286 A1
(43) Pub. Date: Mar. 4, 2010

(54) CLAMPING DEVICE

(76) Inventor: Marzell Maier, Isny/Sommersbach (DE)

Correspondence Address: Karl F Milde Jr;MILDE & HOFFBERG, 10 Bank Street, Suite 460, White Plains, NY, 10606, US

(21) Appl. No.: 12/448,267

(22) PCT Filed: Dec. 28, 2007
(86) PCT No.: PCT/EP2007/011454

§ 371 Date: Jun. 15, 2009

(30) Foreign Application Priority Data
Jan. 9, 2007 (DE) 10 2007 001 440.8
Aug. 27, 2007 (DE) 20 2007 011 976.3

(51) Int. Cl. B62K 19/36; A44B 99/00; B62J 1/06

(52) U.S. Cl. 280/281.1; 24/458

(57) ABSTRACT

A clamping device for fixing a tubular object (S), in particular for a seat post (S), comprises at least a clamping area (6, 7) which, under pressure, is elastically deformable and media feed lines (8, 9) to the clamping areas (6, 7). Set under pressure, the tubular object is fixed in a force-fit manner and without clearance. Used on a bicycle, e.g. the seat post (S) can be height-adjusted by means of a remote control (F) during a ride.

The invention concerns a clamping device for a releasable force-fit fixing of a tubular object composed of a sleeve comprising at least a clamping area which, under pressure, is elastically deformable. Such devices are necessary in techniques for different applications. In telescopic tubes, for instance, sleeve and covering body must be fixed with each other. In length-adjustable ski sticks a cone is strut for example by means of a thread rod, which cone is thereby clamped in the covering body. In parasol supports and similar a sleeve nut presses an annular clamping device against the sleeve. In mechanical engineering a clamping device is used to fix shafts with hubs.

From the DE-OS 43 30 634 is known a device for clamping an axially movable rod, wherein the rod is surrounded by a fourfold longitudinally slotted sleeve. The sleeve is surrounded by an elastic shell to which is applied a hydraulic pressure, whereby the tabs of the sleeve are pressed against the rod and are fixed to the said rod.

From the DE-OS 3000637 is known a releasable force-fit fixing of a shaft in a collar wherein the bore surface of the collar bears an intermediate ring, which is composed of individual ring segments which can be adjusted hydraulically to the collar. Thereby, the individual ring segments can, independently from another, be loaded via an adjusting element each time by means of pressure means.

The DE 200 22 353 U1 exhibits a clamping sleeve for the construction of tools and devices which surrounds a columnar body and is surrounded on her part externally by a pressure chamber, during whose application the clamping sleeve clamps the body in a force-fit manner, whereby the overall clamping sleeve is also deformed in the direction of the pressure chamber, and needs much place.

The known hydraulic clamping devices has the drawback that they are constructively complex and can therefore not be realized particularly compact and are relatively heavy.

It is therefore the objective of the invention to realize a clamping sleeve which avoids these drawbacks. A new clamping device was found which can be used for a multitude of technical clamping connections.

The solution of this task consists in the fact, that the commonly fed media lines are provided for each clamping area of the sleeve, whereby each clamping area (6, 7) is formed by a recess at the external shell of the sleeve (2) and the external shell of the sleeve is pressure-tight covered by a covering body (1). If the clamping areas are loaded by pressure, the rest of the sleeve is not deformed. The clamping areas are realized in a manner that the rest of the material meets the requirements for an elastic deformability and stability.

The tubular object, which is fixed by the clamping device, can exhibit itself each possible form. It can have a round cross section and can be a tube or a cylinder rod. The cross section can also be polygonal; it could in particular exhibit the form of a regular polygon. Thereby the object in the clamping device can be fixed somewhat radially. According to this application the term “tubular” should comprise all tubular objects with different cross sections, namely hollow objects or such objects of solid material.

The clamping device itself must be realized in a manner which is adapted to fix the object by means of the elastically deformable clamping area, i.e., if the clamping area is pressed by means of an elastic deformation against the object, the clamping device must be realized in a manner that a counter bearing to the clamping area exists. Tubular bodies according to the mentioned definition meet in general these requirements.

When a multitude of clamping areas is axially and/or radially distributed disposed, the clamping effect is enforced and/or symmetrised.

The media feed lines can be advantageously introduced in form of channels into the internal shell of the covering body and/or into external shell of the sleeve, for example through milling. If it depends less on the compact construction, for example also thin tubes can be inserted in the form of media feed lines into accordingly provided channels.

The invention can be advantageously used for a hydraulic fixing of a seat post. Seat posts for fixing bicycle seats are usually fixed with a mechanic gripper clamp in the seat tube Thereby the seat tube is generally slit at the upper end so that the circumference of the tube can be reduced due to the clamping effect and that the seat tube is applied force-fitted to the seat post. The gripper clamp is generally torqued down with a nut or a quick-release-skewer is used, wherein the clamping force is attained in moving a lever. It is possible with such a quick-release-skewer is used to fix the saddle without a tool. This is for example necessary when the bicycle shall be driven by persons with different sizes or when the saddle height must be adapted to the same person due to certain conditions. The latter is for example the case for rides in difficult territories, as it occurs in particular during mountain biking. Uphill the saddle height must be adjusted in an ergonomically optimal manner, for attaining a good load transmission. During downhill run the driver must displace his centre of gravity rearward and downward according to the steepness and difficulty and must furthermore often displace his fundament behind the saddle. The deeper the saddle the easer it is for the driver to displace actively and dynamically his centre of gravity, but looses therefore his lateral guiding forces, that he can obtain for an accordingly height adjusted saddle with the internal sides of his shanks against the saddle. The optimal height of the saddle depends therefore on the corresponding driving situation.

The drawback of the known clamping device consists of the fact, that the driver must descend each time and adjust the height of the saddle. It is therefore desirable to realize a device for the height adjustment of a bicycle saddle, which the driver can adjust during the trip. Such supports are provided on the market. In issue 11, 2006 of the magazine BIKE (Delius Klasing Verlag) is provided a test of so-called vario-seat posts. One of these two systems of the presented posts works with two oil chambers, which are interconnected via a valve. The opening of the valve by means of the actuator, a tube can be moved up and down in the shaft. For attaining an upward force action, the lower oil chamber is filled in addition with air. The so generated pressure pushes the post in drawing the actuator and a simultaneous discharge upwards.

This mechanism is on one hand complex and on the other hand the seat post must have a certain clearance in the shaft for being able to adjust the height of the seat post. The seat post is therefore—also if the valve is closed—not fixed in an optimal manner. Furthermore the systems which are described in the test offer only a constructional restricted seventy-five millimetre adjustment range.

According to this invention the sleeve is exactly surrounded in a perfect fitting by an external tube in the form of a covering body respectively another sleeve. Both sleeves are interconnected in an advantageous manner in welding, sticking, etc. of a certain zone, for example at the upper and lower end, so that a medium, generally a fluid, introduced under pressure via the media feed lines, is not permitted to escape between the sleeves. This can be avoided by other means, for example in arranging washers as for example o-rings etc.

Therefore an efficient height-adjustable seat post clamping can be realized by means of a clamping device according to the invention. The tubular object to be fixed by means of the clamping area is, for example, a seat post for a bicycle saddle. In this way a simple, effective and sure clamping of the seat post can be realized.

The hydraulic seat post clamping device cannot only be realized with the clamping device according to the invention, but can also be realized, for example, by means of the known, in particular hydraulic clamping. It is furthermore possible to use other hydraulically actionable devices for clamping a seat post. Such devices are known in bicycles in hydraulically actionable brakes (MAGURA) and in disk brakes. They can be used in a corresponding construction for the proposed solution of a height-adjustable seat post. This construction, which is less compact compared to the device according to the invention, is not unfavourable in certain domains of mountain biking, for example in the so called downhill, because the robustness is more important than the reduction of weight. The invention enriches the art only by the fact that the principle of hydraulic clamping is applied to height-adjustable seat posts.

In all seat post clamping devices according to the invention the seat post can be loaded with a spring, which be for example a gas pressure spring, a spiral spring, or an elastomer. So it is possible to realize an especially remote height-adjustment of a seat post during the trip.

According to an embodiment of the invention the clamping device is realized so that it can be integrated into the seat post of a bicycle frame or can even form a constructive unit with the said seat post. It is possible in the first case to sell a seat post with the clamping device as an accessory. In the second case it is possible to save place and weight because a portion of the seat tube can form simultaneously the covering body of the clamping device in integrating the media feed lines.

When the seat post be adjusted during the trip, it is advantageous to provide means which avoid the rotation of seat post around the longitudinal axis. This could be, for example, longitudinal construction, a tongue and groove construction or a polygonal internal and seat tube or similar.

A particularly advantageous embodiment of the clamping device is that the elastically deformable clamping area is the sleeve itself, whereby the sleeve is composed in particular of plastics. When the sleeve itself is sufficiently elastically deformable, no special clamping areas must be realized. A plastics sleeve has the advantage that it is relatively light and shows good sliding possibilities. Any other material can be used which is correspondingly elastically deformable.

In the previous described embodiment the medium, for example a hydraulic medium can be pressed directly between the covering body and the sleeve. An easier distribution and so an optimized pressure application is attained when at least one media feed line is provided which is introduced in particular into the sleeve (21) in the form of a circumferential channel in the form of a spiral.

It is evident for the person skilled in the art, that the clamping device according to the invention can be realized also according to the principle of the cinematic inversion in a matter that the clamping areas act towards the exterior and fix a body surrounding the sleeve. The solution of such a task consists in a clamping device for a releasable force-fit fixing of an object composed of a sleeve, which comprises at least one clamping area which is elastically deformable under pressure, whereby simultaneously fed media lines are provided for each clamping area, and whereby each clamping area is realized by a recess at the internal shell of the sleeve and the internal shell of the sleeve is closed in a pressure tight manner. Also in this clamping device the clamping areas can be disposed in an axially and/or radially distributed manner to obtain an optimal clamping.

When the connection between the covering body and the sleeve is realized in that these both elements can be rotated in relation to each other during the application of a pressure, it is advantageous to provide an anti-rotation-safety device between the sleeve and the covering body.

The proposed clamping devices can be a part of a height-adjustable seat post which is marketable as a structural unit. A particular compact embodiment can be obtained when the tube of the seat post forms simultaneously the external shell of a gas pressure spring, i.e. when the gas pressure spring is integrated in the seat tube.

A gas pressure spring integrated into the seat tube wherein the tube of the seat post forms simultaneously the external shell of the gas pressure spring is considered separately as an invention.

An example of an embodiment of the invention is described in the following by means of the drawings, wherein:

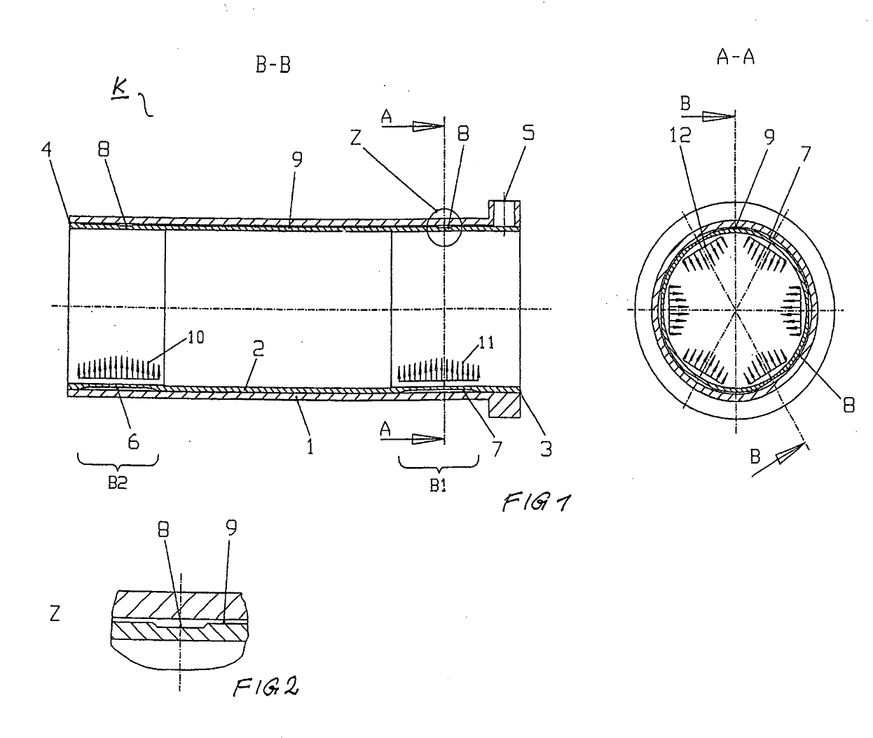

FIG. 1 a clamping device in the lateral view (cross-section B-B) and in the top view (line A-A).

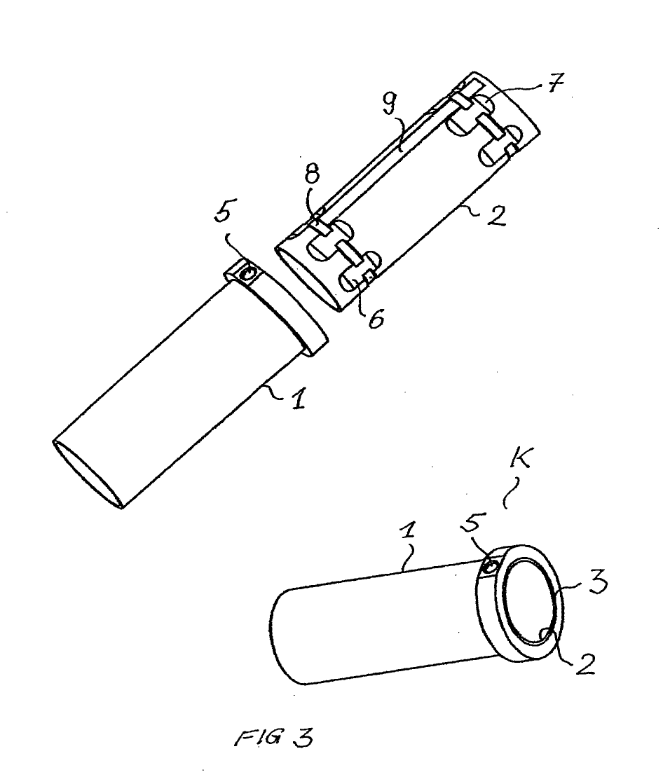

FIG. 2 a detail representation of the detail Z from the lateral view B-B.

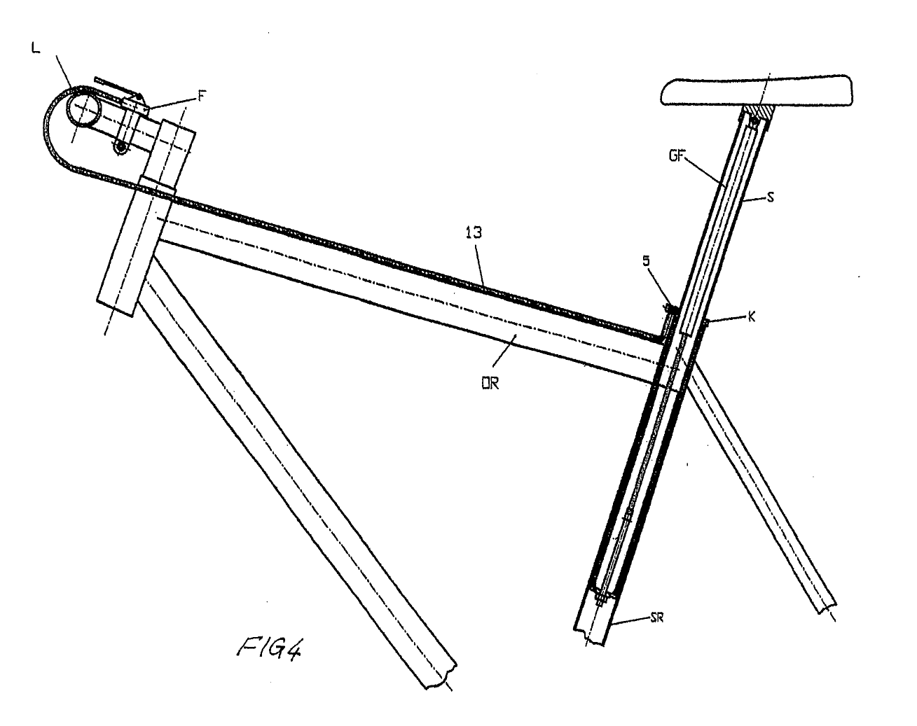

FIG. 3 an exploded drawing of the clamping device.

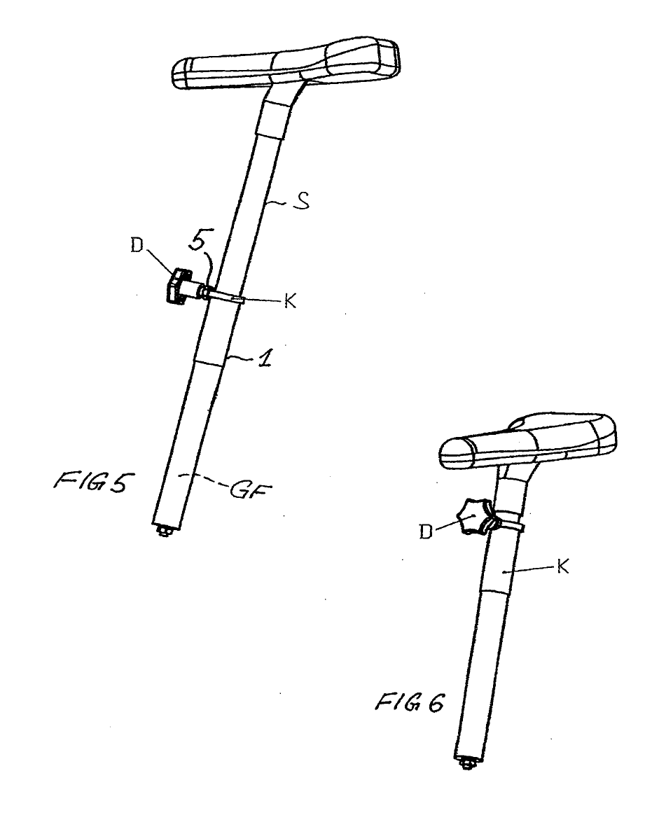

FIG. 4 a detail from the bicycle frame with a height-adjustable seat post.

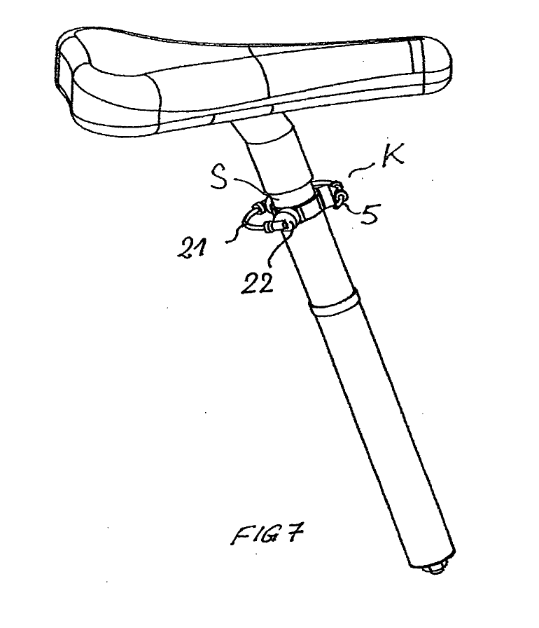

FIG. 5 a seat post with a clamping device with a high adjusted saddle.

FIG. 6 a seat post with a clamping device with a low adjusted saddle.

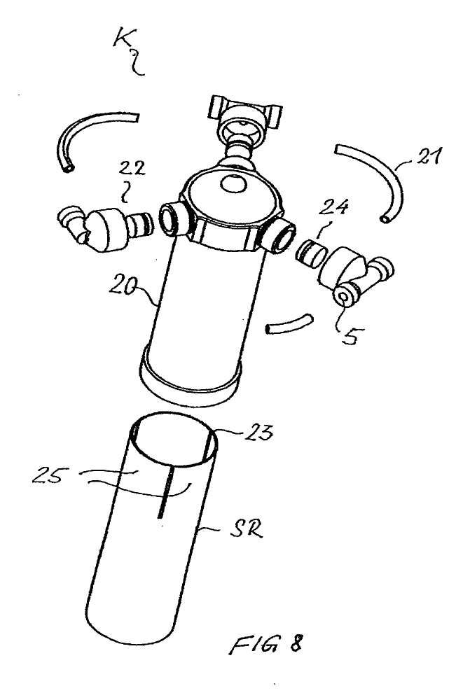

FIG. 7 a seat post with an alternative hydraulic clamping device.

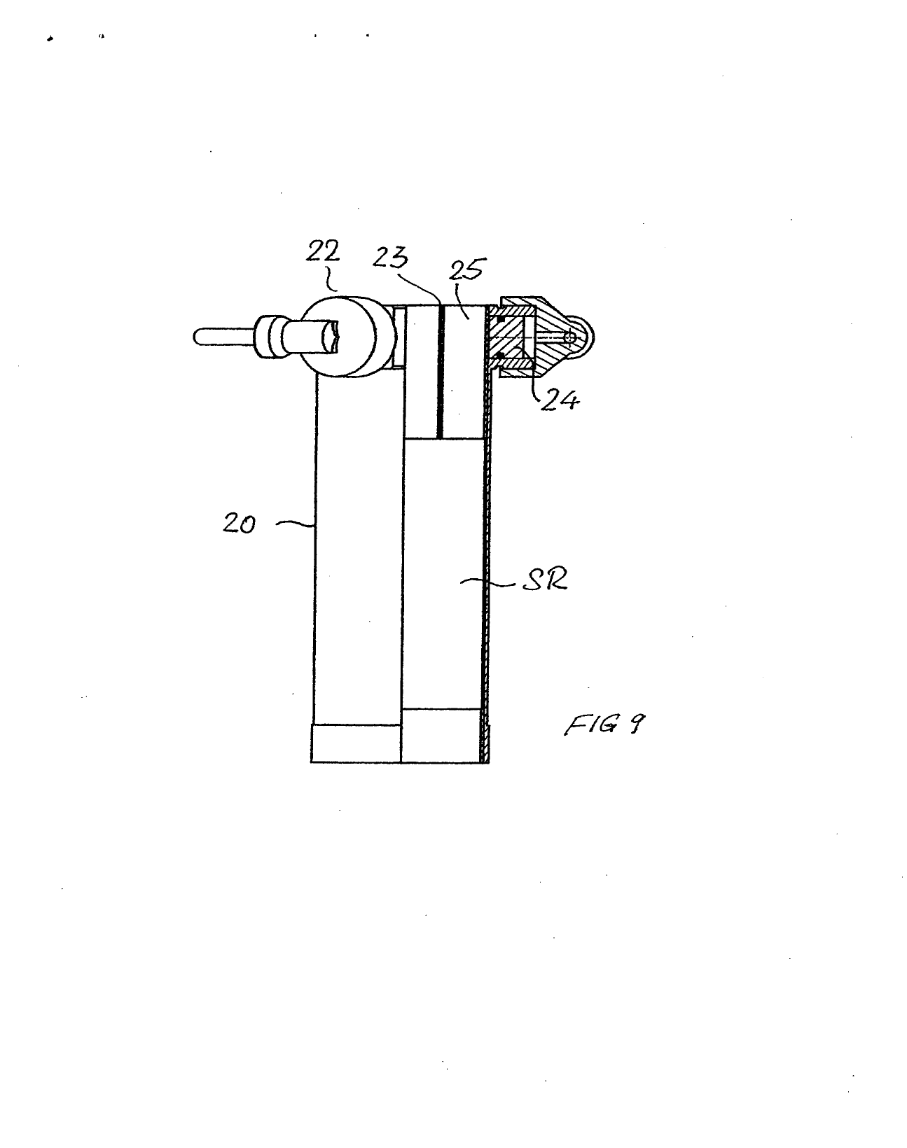

FIG. 8 an exploded drawing of the alternative hydraulic clamping device.

FIG. 9 a three-dimensional schematic drawing of the alternative hydraulic clamping device.

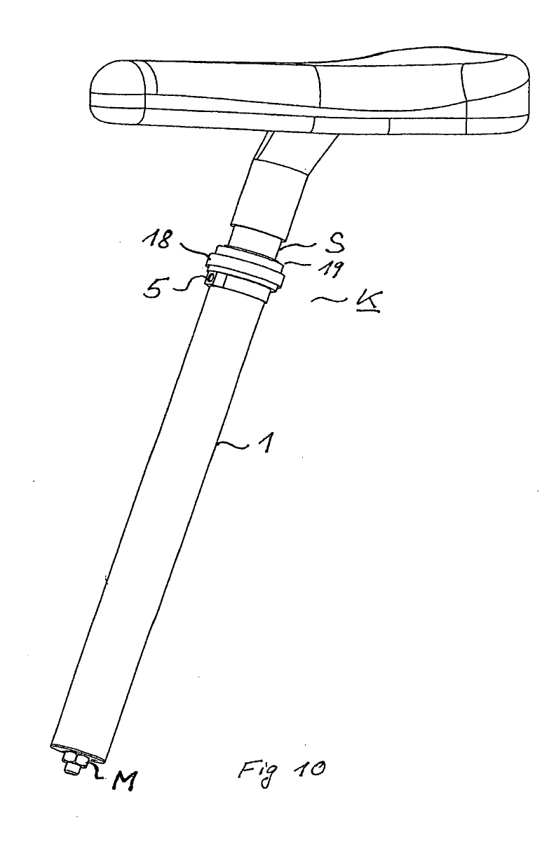

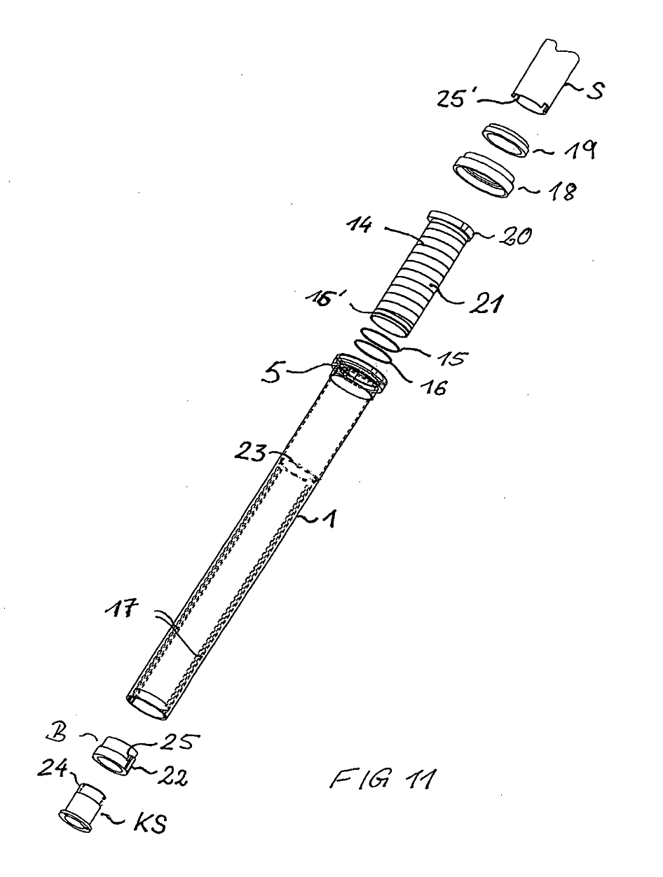

FIG. 10 a seat post with a second alternative hydraulic clamping device.

FIG. 11 an exploded drawing of the second alternative hydraulic clamping device.

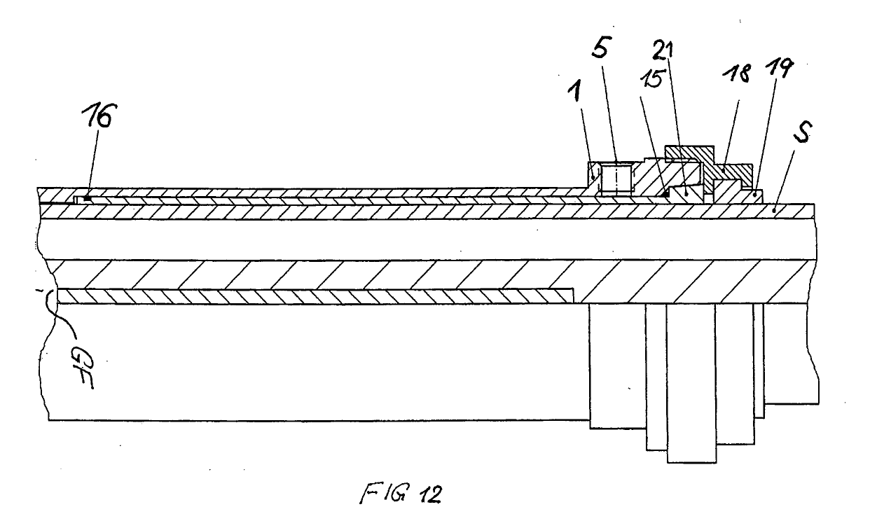

FIG. 12 a cross section drawing of the second alternative hydraulic clamping device.

The FIG. 1 shows a clamping device K in a lateral view (cross-section B-B) and in a top view (cross-section A-A). The device consists of an external tube as a covering body 1 in which a sleeve 2 is introduced, for example in the form of a shrink- or press-fit. The both tubes are interconnected at the top and at the bottom at the positions 3 and 4. The connection can be a welding connection, a solder connection, a sticking connection or a screw or any other connection who meets the purpose. According to the realization of the media feed line described below, the connection must be realized eventually media tight. Upper clamping tapering 7 (recesses) are introduced In the region B1 via the circumference of the sleeve 2 and lower clamping tapering 6 are introduced In the region B2 via the circumference of the sleeve 2. These clamping tapering 6, 7 are realized for example in milling the external shell of the sleeve 2 and form the internal sides of the clamping areas 6, 7.

The media feed line 5 is situated at the covering body 1. Via this media feed line a medium preferably incompressible like oil (hydraulic oil) is introduced. In the internal shell of the covering shell 1 and/or in the external shell of the sleeve 2 are provided radial and axial media feed lines 8 and 9, wherein the medium can be transferred to the inner side of the elastic clamping areas 6, 7. The media feed lines 8, 9 are manufactured for example in milling grooves in the shell surfaces. In other embodiments tube feed lines can be used, which can be introduced for example in deeper millings or can be admitted from the exterior. The radial, symmetrically chosen distribution in the example of realization of the clamping areas 6, 7 can be clearly recognized in the cross section A-A. If the symmetry of the clamping is not important, another distribution, for example, a unilateral distribution of the clamping areas can be chosen.

FIG. 2 shows a magnified representation of the detail Z of the lateral view B-B. In this figure the radial media feed line 8 and the axial media feed line 9 can be clearly recognized. These media feed lines 8, 9 connect all internal sides of the elastic clamping areas 6, 7.

In the exploded drawing according to FIG. 3, the construction of the clamping device is additionally made clearer in using identical reference numbers.

When a medium, for example oil or another hydraulic liquid is transferred under pressure via the radial media feed line 5 and the radial and axial media feed lines 8, 9 on the internal side of the elastically clamping areas 6, 7, these surfaces are deformed elastically radial to the interior in the direction of the force arrows 10, 11, 12 (FIG. 1) and fix a tube which is not represented in FIG. 2 and which is introduced into the sleeve 2. The hydraulic system is evacuated before it is filled with the hydraulic liquid. Eventually an air vent screw or similar can be provided.

The constructive realization of the covering body 1 and of the sleeve 2, the radial and axial media feed lines 8, 9, of the lower and upper clamping taperings as well as there number and distribution on the circumference may be realized by the person skilled in the art. It depends essentially on the dimensions and the desired clamping force. For a clamping device K for a seat post S the covering body has for example a length of 85 mm and an external diameter of 31, 6 mm, adapted to the seat tube SR, with a tube thickness of 1, 2 mm. The sleeve 2 has the same length and a tube thickness of 1 mm. The clamping taperings 6, 7 have 120 mm² (square millimeter) and are tapering from the external border to the middle to a material thickness of approximately 0, 4 mm. The residual material thickness depends on the material itself as well as on the available pressure and the necessary electrical deformation.

Embodiments for the cinematic inversion of the clamping device according to the invention can be realized by the person skilled in the art within the bounds of his skill.

FIG. 4 shows a detail of a bicycle frame with a high seat post S. The clamping device K can be introduced into the seat tube SR. Within the seat post S is the gas pressure spring GF, which is supported on the lower end of the clamping device K. The clamping device K or only the external tube 1 or the sleeve 2 can be, according to the requirements, longer than it is shown in FIG. 1. A hydraulic line 13 is connected to the radial media feed line 5, which hydraulic line is conducted along the upper tube OR of the bicycle frame to the handle bar L and ends at a remote control F. The fixing of clamping device K can be activated via the operation of the lever of the lockable remote control, for example, according to the knee lever principle. If it is released, the seat post S can be pushed down by the weight of the driver and can be deployed by relief during the ride, whereby the two hands of the driver can stay on the handle bar. The constructive realization of a corresponding remote control device depends on the skill of the person skilled in the art. In the construction of bicycles, especially for mountain bikes hydraulic systems already exist, for example to actuate disk brakes. Instead of the gas pressure spring also a normal spiral spring etc. can be used.

FIG. 5 shows a detail of a bicycle frame with a seat post S in a high adjusted position. In opposition to the FIG. 4 no remote control device is shown, but the actuation of the clamping device K is realized directly on this device itself by means of a turning knob D below the saddle. FIG. 6 shows the same hydraulic seat post clamping as FIG. 5 in a low adjusted position.

The clamping device K according to the invention operates reliably and due to the frictional connection has no play, so that on the one hand creak noises—even under dynamical load—are avoided and on the other hand no wear and tear, depending on the clearance, exists. The radial clamping force operates uniformly on the seat post S and clamps it in an optimal manner with high stiffness. In a non clamped state the seat post is guided approximately without clearance in the clamping zones, so that the seat tube can be moved easily. In the solution described in this text a reasonable adjustment range of 180 mm (hundred and eighty) can be realized. Furthermore the gas pressure spring is arranged in a protected manner in the seat point. The clamping device can be manufactured in a compact and easy manner.

The FIGS. 7, 8 and 9 show an alternative hydraulic clamping device K for fastening a seat post S. Thereby are arranged on the circumference of a sleeve 20 three piston devices 22, operating according to the principle of a disk brake found for example in bicycles. The piston devices 22 are interconnected via common hydraulic lines 21, wherein the hydraulic fluid is introduced via the media feed line 5. The sleeve 20 is slided from the exterior on the—here only shown—upper end of the seat tube SR (see also FIG. 4) and is fixed on this tube. The seat tube SR is provided at the upper end distributed on its circumference with slots 23. During pressure application the bolts are pressed on the external shell of the seat tube SR whereby these bolts press the plates 25 of the seat tube SR in a force-fit manner on the seat post.

FIG. 9 shows a three-dimensional schematic drawing of the alternative hydraulic clamping device, whereby the right half is shown in cross section and enables the view on the seat tube SR and the piston device 22.

The FIG. 10 shows the schematic drawing of a seat post S with a second alternative embodiment of the clamping device K, which is described in the following more in detail by means of the FIGS. 11 and 12.

In the exploded drawing according to FIG. 11 are represented from the top to the bottom: The lower end piece of a seat post to be clamped, a soil wipe off ring 19, a lock nut 18, an elastically deformable clamping sleeve 21, which can be made, for example, of plastics and which comprises a helicoidally circumferential channel 14 for receiving the pressure liquid and on the upper end thereof having provided a polygon 20 as a part of a anti-rotation safety between the sleeve and the covering body. The polygon 20 is realized in a conical manner and tapers from the top the bottom. At the lower end of the covering body 21 is provided a circumferential cut-in groove 16′ for receiving the following described sealing washer 16.

The reference numbers 15 and 16 indicate an upper and a lower sealing washer. The covering body 1 is found beneath. The sealing washers 15, 16 which can be for example o-rings, are mounted in the zone of the upper and lower end of the clamping sleeve 21 and avoid the discharge of the hydraulic liquid between the covering body 1 and the sleeve 21.

A recess is found at the upper portion of the covering body, i.e. the internal diameter is up to n the dashed—line 23 greater than in the Portion situated below. The sleeve 21 is adapted to the recess The polygon 20 of the clamping sleeve 21 founds a conical counter-fit at the top of the covering body 1, so that the clamping sleeve 21 and the covering body 1 cannot be furthermore twisted one to each other.

Below the reception 16′ for the washer, the covering body is provided at the interior with two dashed indicated longitudinal grooves 17. Theses grooves receive the springs 22 of a socket B (which can be made of plastics). The socket B itself is connected with the lower end of the seat post. For that purpose the seat post is inserted through the covering body. The socket B operates then as an anti-rotation safety in the released state, i.e. the pressure free state and simultaneously as an upper abutment safety, so that the seat post cannot leave the clamping device in the released state.

The connection between the seat tube S and the socket B is realized by means of a clamping screw KS. The latter comprises a thread 24, which is screwed into a—for clearness reasons not represented—counter thread in the internal tube of the seat post S. Thereby the groove 25 of the socket engages with the recess 25′ of the seat tube, so that the anti-rotation connection of the socket B is realized with the seat tube.

FIG. 12 shows a three-dimensional schematic drawing of the second alternative hydraulic clamping device, whereby the left half is presented in a cross section. The same reference numbers are used for the same elements. Especially the principle of the gas pressure spring GF integrated into the seat post S can be recognized.

The clamping device unit with seat post represented in the FIG. 10 which is structurally and independently sellable—with or without a saddle—comprises furthermore a nut M. The individual elevation height of the gas pressure spring GF can be adjusted.

What is claimed is:

1. Clamping device for a releasable force-fit fixing of a tubular object having a sleeve, said device comprising at least one clamping area which, under pressure, is elastically deformable, the improvement wherein jointly supplied media feed lines are provided for each clamping area, each clamping area being formed by a recess at the external shell of the sleeve, and wherein the external shell of the sleeve is surrounded pressure-tight by a covering body.

2. Clamping device according to claim 1, wherein the clamping areas are disposed and distributed on the sleeve at least one of axially and radially.

3. Clamping device according to claim 1, wherein the media feed lines are inserted in form of channels in at least one of the internal shell of the covering body and in the external shell of the sleeve.

4. Clamping device according to claim 1, wherein the tubular object is a seat post.

5. Clamping device for a releasable force-fit fixing of a seat post, the improvement comprising at least one clamping area which is force-locked with a seat post upon application of hydraulic pressure.

6. Clamping device according to claim 5, comprising a sleeve which receives the seat post, comprising at least a one clamping area which, under pressure, is elastically deformable, wherein at least one media feed line is provided for at least one clamping area, and wherein the external shell of the sleeve is surrounded pressure-tight by a covering body.

7. Clamping device according to claim 5, wherein a spring force is applied to the seat post in an axial direction.

8. Clamping device according to claim 7, wherein the spring force is produced by a gas pressure spring.

9. Clamping device according to claim 8, wherein the device is applied to the seat tube of a bicycle frame.

10. Clamping device according to claim 8, wherein the device forms a constructional unit with a seat tube of a bicycle.

11. Clamping device according to claim 10, further comprising means for avoiding a rotation of the tubular object relative to the seat post in the clamping device.

12. Clamping device according to claim 6, wherein the elastically deformable clamping area is on the sleeve itself.

13. Clamping device according to claim 6, wherein the media feed line includes a channel in the sleeve.

14. Clamping device for a releasable force-fit fixing of an object having a sleeve, said device comprising at least one clamping area which, under pressure, is elastically deformable, the improvement wherein jointly supplied media feed lines are provided for each clamping area, each clamping area being formed by a recess at the internal shell of the sleeve, and wherein the internal shell of the sleeve is sealed in a pressure-tight manner.

15. Clamping device according to claim 14, wherein the clamping areas are disposed and distributed at least one of axially and radially.

16. Clamping device according to to claim 1, further comprising anti-rotation safety means disposed between the sleeve and the covering body.

17. Height adjustable seat post having a clamping device according to claim 1.

18. Height adjustable seat post according to claim 17, wherein a tube of the seat post forms the external shell of a gas pressure spring.

19. Height adjustable seat post, wherein a tube of the seat post forms the external shell of a gas pressure spring.

20. Clamping device according to claim 12, wherein the sleeve is made of a plastic material.
